(19) United States
(12) Patent Application Publication
(10) Pub. No.: US 2026/0338926 A1
(43) Pub. Date: Oct. 29, 2026

(54) METHOD FOR DISTANCE MEASUREMENT IN FMCW LIDAR, FMCW LIDAR, AND DISTANCE MEASURING DEVICE

(71) Applicant: AUTOX TECH PTE. LTD., SINGAPORE (SG)

(72) Inventors: Jiabing Fan, Shenzhen (CN); Yanan Zhi, Shenzhen (CN); Jianxiong Xiao, Shenzhen (CN); Yizhou Shan, Shenzhen (CN)

(73) Assignee: AUTOX TECH PTE. LTD., SINGAPORE (SG)

(21) Appl. No.: 19/191,000

(22) Filed: Apr. 28, 2025

(51) Int. Cl. G01S 7/4912; G01S 17/32

(52) U.S. Cl. CPC G01S 7/4912; G01S 17/32

(57) ABSTRACT

The disclosure provides a method for distance measurement in an FMCW LiDAR, an FMCW LiDAR, and a distance measuring device. The method includes steps of: performing an FFT on a difference frequency signal to obtain multiple transformed frequencies, and an amplitude corresponding to each transformed frequency; conducting a CFAR detection among the multiple transformed frequencies to detect a target frequency; performing a coarse frequency estimation based on the FFT on the target frequency to obtain a coarse estimated value of the target frequency, which being configured to calculate a difference frequency corresponding to a measured distance; conducting a fine frequency estimation based on a DFT on the coarse estimated value to obtain a fine estimated value of the target frequency, which being configured to calculate the difference frequency corresponding to the measured distance; calculating the coarse estimated value and the fine estimated value to obtain the difference frequency.

### TECHNICAL FIELD

This application relates to the technical field of radar ranging, particularly to a method for distance measurement in an FMCW LiDAR, an FMCW LiDAR, and a distance measuring device.

### BACKGROUND

FMCW (Frequency Modulated Continuous Wave) is an advanced laser ranging technology characterized by wide ranging distance, high ranging accuracy, and the ability to achieve non-contact ranging without cooperative targets. Additionally, it offers high real-time performance, a simple structure, and good system compatibility.

An on-vehicle LiDAR based on FMCW ranging technology typically employs a frequency estimation algorithm based on a fast Fourier transform (FFT) for frequency extraction of the difference frequency signal. By converting the difference frequency signal to the frequency domain and searching for peaks in a spectrum, the frequency corresponding to the maximum peak is taken as the frequency of the difference frequency signal, from which a distance to the target is derived. Utilizing the FFT for frequency extraction offers fast computation speed, significant optimization potential, and simple hardware implementation, making it highly suitable as a signal processing solution in real-time systems for distance measurement.

However, selecting the maximum peak in the FFT has notable drawbacks. Firstly, it is affected by an fence effect, resulting in insufficient calculation accuracy. In prior art, combining the FFT with an inverse fast Fourier transform (IFFT) multiple times, while achieving the required accuracy, leads to high overall computational complexity, which is detrimental to real-time calculations. Secondly, in detection environments with strong interference or significant background noise within a certain frequency band, and when the amplitude of the interference or noise signal frequency exceeds that of the target signal frequency, this approach may extract the interference signal as the target frequency, causing errors in frequency estimation and severely impacting the accuracy of distance information between the target and the radar. In prior art, constant false alarm rate (CFAR) detection is configured to filter out interference and noise, but its detection performance rapidly decreases in complex backgrounds and when a quantity of interfering targets exceeds a certain limit, failing to effectively eliminate strong clutter within a specific frequency band.

### SUMMARY

Disclosed are a method for distance measurement in an FMCW LiDAR, an FMCW LiDAR, and a distance measuring device which achieve the analysis of the difference frequency signal generated by the LiDAR while eliminating signals and interference frequencies within specified frequency bands, thereby obtaining a target distance.

In a first aspect, the method provided includes steps of: performing an FFT on a difference frequency signal containing target state information to obtain multiple transformed frequencies, and an amplitude corresponding to each transformed frequency; conducting a CFAR detection among the multiple transformed frequencies to detect a target frequency; performing a coarse frequency estimation based on the FFT on the target frequency to obtain a coarse estimated value of the target frequency, the coarse estimated value being configured to calculate a difference frequency corresponding to a measured distance; conducting a fine frequency estimation based on a DFT on the coarse estimated value to obtain a fine estimated value of the target frequency, the fine estimated value being configured to calculate the difference frequency corresponding to the measured distance; calculating the coarse estimated value and the fine estimated value to obtain the difference frequency.

In a second aspect, the FMCW LiDAR provided includes a memory, and a processor, the memory is configured to store computer programs; the processor is configured to execute the computer programs to implement the method for distance measurement in the FMCW LiDAR, the method includes steps of: performing the FFT on the difference frequency signal containing target state information to obtain multiple transformed frequencies, and the amplitude corresponding to each transformed frequency; conducting the CFAR detection among the multiple transformed frequencies to detect the target frequency; performing the coarse frequency estimation based on the FFT on the target frequency to obtain the coarse estimated value of the target frequency, the coarse estimated value being configured to calculate the difference frequency corresponding to the measured distance; conducting the fine frequency estimation based on the DFT on the coarse estimated value to obtain the fine estimated value of the target frequency, the fine estimated value being configured to calculate the difference frequency corresponding to the measured distance; calculating the coarse estimated value and the fine estimated value to obtain the difference frequency.

In a third aspect, the distance measuring device includes a body, and the FMCW LiDAR, the FMCW LiDAR is installed on the body, the FMCW LiDAR includes the memory, and the processor, the memory is configured to store computer programs; the processor is configured to execute the computer programs to implement the method for distance measurement in the FMCW LiDAR, the method includes steps of: performing the FFT on the difference frequency signal containing target state information to obtain multiple transformed frequencies, and the amplitude corresponding to each transformed frequency; conducting the CFAR detection among the multiple transformed frequencies to detect the target frequency; performing the coarse frequency estimation based on the FFT on the target frequency to obtain the coarse estimated value of the target frequency, the coarse estimated value being configured to calculate the difference frequency corresponding to the measured distance; conducting the fine frequency estimation based on the DFT on the coarse estimated value to obtain the fine estimated value of the target frequency, the fine estimated value being configured to calculate the difference frequency corresponding to the measured distance; calculating the coarse estimated value and the fine estimated value to obtain the difference frequency.

The method for distance measurement in the FMCW LiDAR, the FMCW LiDAR, and the distance measuring device mentioned-above obtain multiple transformed frequencies by performing the FFT on the difference frequency signal and conduct the CFAR detection to acquire the target frequency while eliminating interference frequencies. Then, frequency estimation is performed to obtain the difference frequency, completing the distance measurement. This not only improves the accuracy of the calculation but also eliminates interference frequencies, enabling processing of signals within specific frequency bands.

### BRIEF DESCRIPTION OF THE DRAWINGS

FIG. 1 illustrates a flow diagram of a method for distance measurement in an FMCW LiDAR.

FIG. 2 illustrates a sub-flow diagram of the step S101.

FIG. 3 illustrates a sub-flow diagram of the step S102.

FIG. 4 illustrates a sub-flow diagram of the step S1022.

FIG. 5 illustrates a sub-flow diagram of the step S1023.

FIG. 6 illustrates a sub-flow diagram of the step S104.

FIG. 7 illustrates a sub-flow diagram of the step S1041.

FIG. 8 illustrates a structure diagram of an FMCW LiDAR.

FIG. 9 illustrates a structure diagram of a distance measuring device containing an FMCW LiDAR.

FIG. 10 illustrates a schematic diagram of acquiring a difference frequency signal.

FIG. 11 illustrates a schematic diagram of a detection effect of CFAR.

FIG. 12 illustrates a schematic diagram of comparing frequency estimation errors.

### DETAILED DESCRIPTION OF THE EMBODIMENTS

In order to make the purpose, technical solution and advantages of the invention more clearly, the invention is further described in detail in combination with the drawings and embodiments. It is understood that the specific embodiments described herein are used only to explain the invention and are not configured to define it. On the basis of the embodiments in the invention, all other embodiments obtained by ordinary technicians in this field without any creative effort are covered by the protection of the invention.

The terms “first”, “second”, “third”, “fourth”, if any, in the specification, claims and drawings of this application are configured to distinguish similar objects but need not be configured to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the invention are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the invention.

An FMCW LiDAR based on FMCW laser technology achieves distance measurement of targets by analyzing difference frequency signals generated by the LiDAR. The FMCW LiDAR has characteristics such as a wide measurement range, high ranging accuracy, and the ability to achieve non-contact ranging without cooperation targets, and is commonly used in non-contact target LiDAR ranging, such as on-vehicle FMCW LiDARs, laser track radars, etc., which are not elaborated herein.

In the presence of a target with an unknown distance, to measure the distance between the target and the LiDAR, the difference frequency signal generated by the LiDAR from the target needs to be first obtained.

Referring to FIG. 10, a schematic diagram of acquiring a difference frequency signal is illustrated. In this embodiment, a frequency-modulated continuous-wave light source 1 generates light beams in a 1550-nm wavelength band, which are split by an optical splitter 2 into probe light for detecting the target and intrinsic light generated by the light beams. The probe light enters a spatial collimator 4 through the transmitting and receiving equipment of a one-way transmission optical fiber circulator 3 and is emitted into the atmosphere by collimating lens. After traveling in the air for a period of time, the probe light strikes surfaces of the target to be measured 5 and reflects back, then is received by the spatial collimator 4. After reception, the probe light is reflected back into a receiving channel of the optical fiber circulator 3 and combined with the intrinsic light via a fiber optic combiner 6. After being mixed and interfered through an optical mixer 7, a difference frequency signal 8 containing target state information is obtained, which includes distance information between the target and the LiDAR.

After obtaining the difference frequency signal, the contained distance information needs to be analyzed to determine the distance between the target and the radar. The present application provides a method for distance measurement in the FMCW LiDAR applied to the FMCW LiDAR, which can delete frequencies in a specified frequency band and, based on the amplitude corresponding to the transformed frequency obtained through an FFT, perform frequency estimation after screening out a target frequency through a CFAR detection, thereby obtaining a required difference frequency. The method improves the accuracy of frequency acquisition, eliminates the impact of interfering frequencies, and reduces the complexity of the calculation process.

After obtaining the difference frequency signal, the contained distance information needs to be analyzed to determine the distance between the target and the radar. The present invention provides a method for distance measurement in the FMCW LiDAR applied to the FMCW LiDAR, which can delete frequencies in a specified frequency band and, based on the amplitude corresponding to the transformed frequency obtained through an FFT, perform frequency estimation after screening out a target frequency through a CFAR detection, thereby obtaining a required difference frequency. The method improves the accuracy of frequency acquisition, eliminates the impact of interfering frequencies, and reduces the complexity of the calculation process.

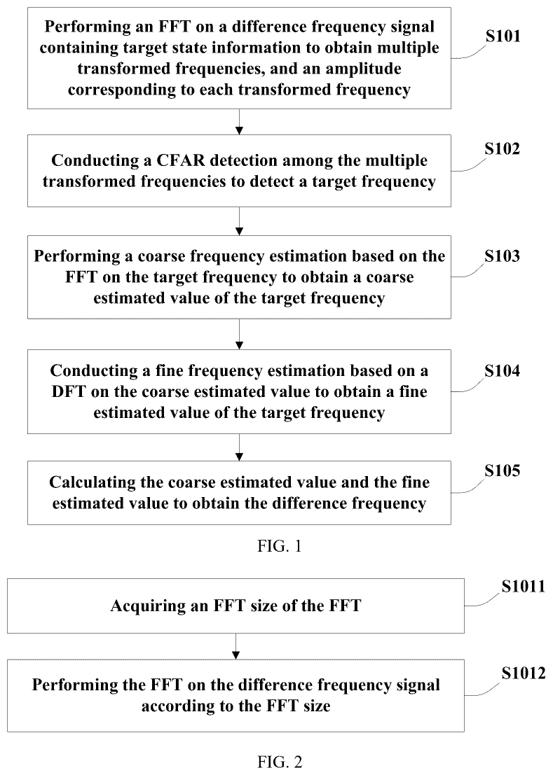

Referring to FIG. 1, a flow diagram of a method for distance measurement in an FMCW LiDAR is illustrated. The method includes follows steps S101-S105.

At the step S101, an FFT is performed on a difference frequency signal containing target state information to obtain multiple transformed frequencies, and an amplitude corresponding to each transformed frequency.

Refer to FIG. 2, a sub-flow diagram of the step S101 is illustrated. The step S101 includes follows steps S1011-S1012.

At the step S1011, an FFT size (number of FFT points) of the FFT is acquired. A quantity of transformed frequencies obtained by the FFT is affected by the FFT size. The FFT size is the number of FFT points in an input differential frequency signal that participate in the FFT. When the quantity of the transform points exceeds the number of FFT points in the differential frequency signal, the differential frequency signal needs to undergo a zero-padding operation to complete a subsequent FFT process.

At the step S1012, the FFT is performed on the difference frequency signal according to the FFT size, with each transformed frequency corresponding to each quantity of transform points.

It is understood that the FFT size affects the computational complexity of the FFT. The larger the FFT size, the less computation time required and the more computations per unit time. An appropriate quantity of transform points balances computation rate and computational complexity.

At the step S102, a CFAR detection is conducted among the multiple transformed frequencies to detect the target frequency. The CFAR detection is a detection method based on sliding windows, configured to filter and remove interference among the transformed frequencies. Specifically, a plurality of frequency thresholds are set in the CFAR detection to delete frequencies within the frequency thresholds and their corresponding amplitudes. In some feasible embodiments, frequencies within the frequency thresholds can be unreasonably erroneous frequencies in a frequency resolution process or interference frequencies from background frequencies in the frequency resolution process, which will not be elaborated herein.

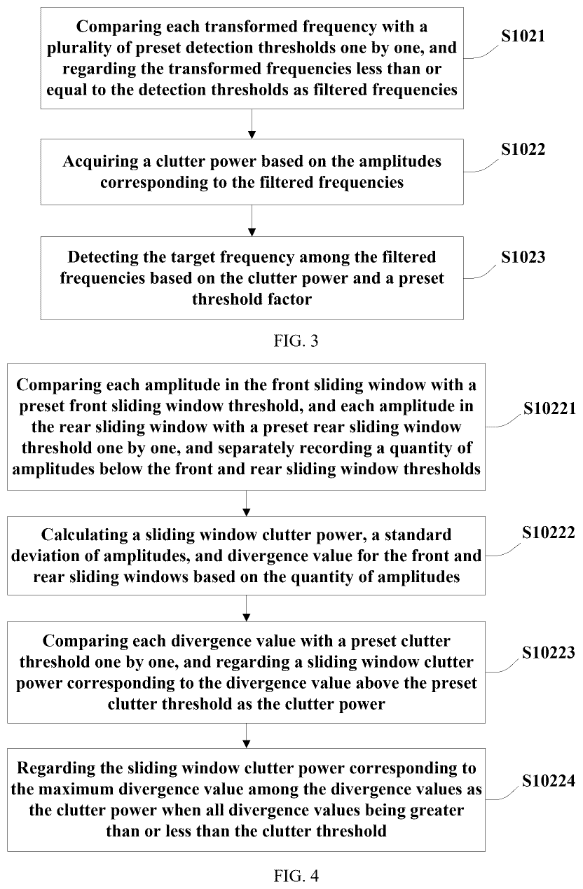

Refer to FIG. 3, a sub-flow diagram of the step S102 is illustrated. The step S102 includes follows steps S1021-S1023.

At the step S1021, each transformed frequency is compared with a plurality of preset detection thresholds one by one, and the transformed frequencies less than or equal to the detection thresholds are regarded as filtered frequencies. The detection thresholds are configured to filter the transformed frequencies obtained in step S101. Each detection threshold has a different size, configured to remove frequency ranges that are not needed in frequency analysis. For example, interference, noise, or frequencies with higher amplitudes outside the desired frequency range, which will not be elaborated herein. Generally, the target frequency corresponds to the maximum amplitude, but if the target frequency is determined directly by the maximum amplitude without detection, the accuracy of the obtained frequency is questionable, and the correctness of the measurement is also not guaranteed.

At the step S1022, a clutter power is acquired based on the amplitudes corresponding to the filtered frequencies. The clutter power is configured to remove interference frequencies. Each amplitude is placed in a detection unit. Each detection unit includes a front sliding window and a rear sliding window. Each sliding window contains a plurality of amplitudes.

Refer to FIG. 4, a sub-flow diagram of the step S1022 is illustrated. The step S1022 includes follows steps S10221-S10224.

At the step S10221, each amplitude in the front sliding window is compared with a preset front sliding window threshold, and each amplitude in the rear sliding window is compared with a preset rear sliding window threshold one by one, and a quantity of amplitudes below the front and rear sliding window thresholds are separately recorded.

At the step S10222, a sliding window clutter power, a standard deviation of amplitudes, and a divergence value for the front and rear sliding windows are calculated based on the quantity of amplitudes. The sliding window clutter power is a cumulative result of each amplitude below the sliding window threshold in the sliding window. A calculation formula for the divergence value is as follows:

$${K}_{i} = \frac{σ - {σ}_{i}}{{σ}_{i}} + ln ( \frac{{σ}_{i}}{σ} ) , i = 1 , 2 ,$$

where K₁ represents a divergence value for the front sliding window, K₂ represents a divergence value for the rear sliding window, σ represents the standard deviation of all amplitudes, σ₁ represents an amplitude standard deviation for the front sliding window, σ₂ represents an amplitude standard deviation for the rear sliding window.

At the step S10223, each divergence value is compared with a preset clutter threshold one by one, and a sliding window clutter power corresponding to the divergence value above the preset clutter threshold is regarded as the clutter power.

At the step S10224, the sliding window clutter power corresponding to the maximum divergence value among the divergence values is regarded as the clutter power when all divergence values are greater than or less than the clutter threshold.

At the step S1023, the target frequency is detected among the filtered frequencies based on the clutter power and a preset threshold factor.

Refer to FIG. 5, a sub-flow diagram of the step S1023 is illustrated. The step S1023 includes steps S10231-S10232.

At the step S10231, an amplitude threshold for the CFAR detection is set based on the clutter power and the preset threshold factor. A calculation formula for the amplitude threshold is as follows:

Z=T*Cₖ,
where Z is the amplitude threshold, T is the preset threshold factor, Cₖ is the clutter power.

At the step S10232, each amplitude is compared with the amplitude threshold one by one, and the maximum value among the filtered frequencies corresponding to the amplitudes greater than the amplitude threshold is regarded as the target frequency.

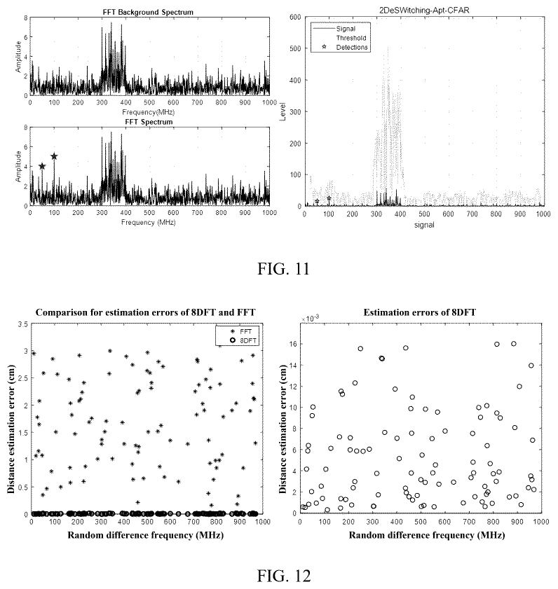

Referring to FIG. 11, a schematic diagram of a detection effect of CFAR is illustrated. Specifically, FIG. 11 is a comparison diagram of the background frequency, the amplitude acquisition frequency of the FFT, and the acquisition frequency after CFAR detection. In step S102, two targets are detected at 50 MHz and 100 MHz, but there is strong interference in the 300-400 MHz frequency band, with amplitudes exceeding the signal frequency amplitude. At this time, if the traditional FFT amplitude acquisition scheme is used to extract the target frequency, a clutter frequency will be selected, resulting in incorrect estimation of the target state. By the CFAR detection, the detection threshold will be adaptively increased in the clutter region, thereby suppressing the influence of clutter on target detection.

At the step S103, a coarse frequency estimation is performed based on the FFT on the target frequency to obtain a coarse estimated value of the target frequency. The coarse estimated value is configured to calculate a difference frequency corresponding to a measured distance.

At the step S104, a fine frequency estimation is conducted based on a DFT on the coarse estimated value to obtain a fine estimated value of the target frequency. The fine estimated value is configured to calculate the difference frequency corresponding to the measured distance.

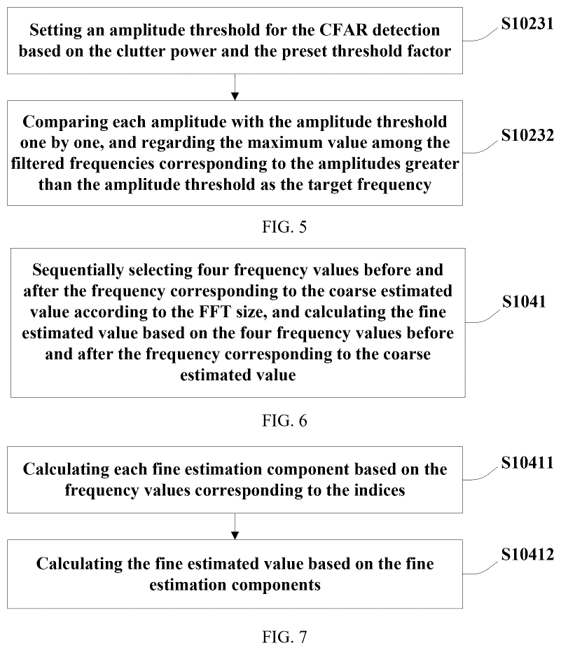

Refer to FIG. 6, a sub-flow diagram of the step S104 is illustrated. The step S104 includes follows step S1041.

At the step S1041, four frequency values before and after the frequency corresponding to the coarse estimated value are sequentially selected according to the FFT size, and the fine estimated value is calculated based on the four frequency values before and after the frequency corresponding to the coarse estimated value. The frequency corresponding to the coarse estimated value is f_{c}, the four frequency values before are f_{c-4}, f_{c-3}, f_{c-2}, f_{c-1}, and the four frequency values after are f_{c+}1, f_{c+}2, f_{c+}3, f_{c+}4, with the frequency values corresponding to indices that are the same as the difference between the index of the frequency corresponding to the coarse estimated value and the index thereof.

Refer to FIG. 7, a sub-flow diagram of the step S1041 is illustrated. The step S1041 includes follows steps S10411-S10412.

At the step S10411, each fine estimation component is calculated based on the frequency values corresponding to the indices. A calculation formula for the fine estimation component is as follows:

$${α}_{k} = \frac{N}{π} {tan}^{- 1} [ tan ( \frac{π}{N} k ) Re \{ \frac{{R}_{c - k} * {e}^{j \frac{π}{N} k} - {R}_{c + k} * {e}^{- j \frac{π}{N} k}}{\frac{2 {R}_{c}}{cos ( \frac{π}{N} k )} - {R}_{c + k} * {e}^{- j \frac{π}{N} k} - {R}_{c - k} * {e}^{j \frac{π}{N} k}} \} ] , k = 1 , 2 , 3 , 4 ,$$

wherein R_{c-k} is the difference between the amplitude corresponding to the kth frequency value before the frequency corresponding to the coarse estimated value and the coarse estimated value, R_{c+k} is the difference between the amplitude corresponding to the kth frequency value after the frequency corresponding to the coarse estimated value and the coarse estimated value.

At the step S10412, the fine estimated value is calculated based on the fine estimation components. A calculation formula for the fine estimate is as follows:

$$α = \frac{{\sum }_{k = 1}^{4} {( \frac{N}{π k} )}^{2} * {α}_{k}}{{\sum }_{k = 1}^{4} {( \frac{Nk}{π} )}^{2}} , k = 1 , 2 , 3 , 4 ,$$

wherein α represents the fine estimate value.

At the step S105, the coarse estimated value and the fine estimated value are calculated to obtain the difference frequency. A calculation formula for the difference frequency configured to calculate the measured distance based on the coarse estimated and the fine estimated is as follows:

fᵣ=f_{c}+α*F_{S}/N,
wherein fᵣ represents the difference frequency, N represents the FFT size, and F_{S} represents the corresponding sampling frequency.

After obtaining the difference frequency, the measurement distance of the LiDAR can be calculated, which is not elaborated here.

Refer to FIG. 12, a schematic diagram of comparing frequency estimation errors is illustrated in FIG. 12. In step S104, difference frequencies within the range of 0-1 GHz are randomly generated, and after 100 Monte Carlo simulations, the errors in distance estimation obtained by amplitude estimation via the FFT and the improved amplitude estimation scheme in this embodiment are shown in FIG. 12. The maximum estimation error in the FFT is 3.125 cm, which is half of the distance resolution. However, the maximum distance estimation error in amplitude estimation in this embodiment is only 0.16 mm. It is evident that using the amplitude estimation scheme in this embodiment for distance estimation can improve the accuracy of distance estimation between the target and the LiDAR.

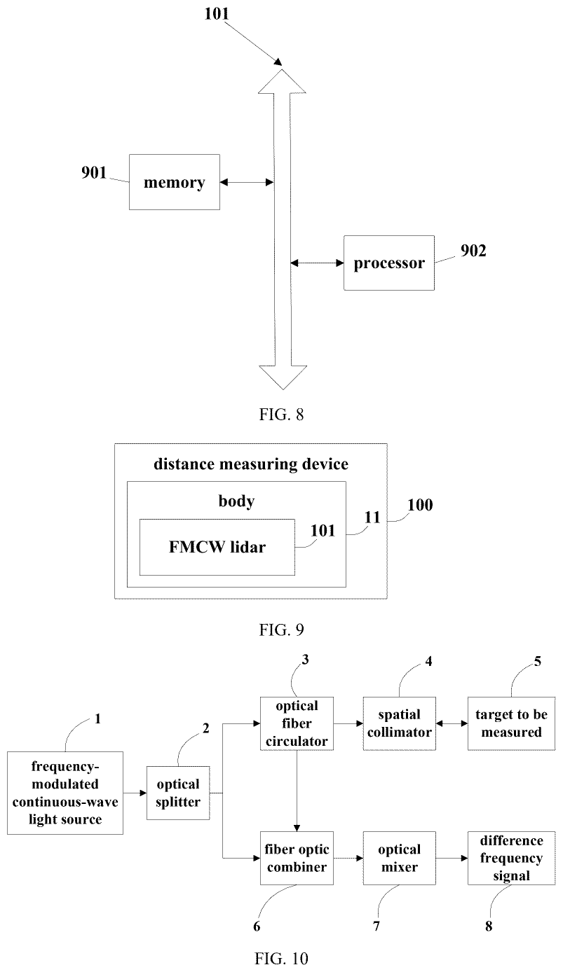

Refer to FIG. 8, a structure diagram of an FMCW LiDAR is illustrated in FIG. 8. The FMCW LiDAR 101 includes a memory 901 and a processor 902. The processor 902 is configured to execute computer programs stored in the memory 901 to implement the method for distance measurement in the FMCW LiDAR.

The memory 901 includes at least one type of computer-readable storage medias, which includes a flash memory, a hard disk, a multimedia card, a card-type storage (for example, an SD or a DX storage, etc.), a magnetic storage, a disk, an optical disk, etc. The memory 901 may in some embodiments be an internal storage unit of a computer device, such as the hard disk of the computer device. The memory 901 may also be an external storage device of the computer device in other embodiments, such as a plug-in hard disk, a Smart Media Card (SMC), a secure digital (SD) card, a flash card, etc., equipped on the computer device. Furthermore, the memory 901 may include both the internal storage unit of the computer device and the external storage device. The memory 901 can not only be used to store application software and all kinds of data installed on a computer device, such as the program instruction of the method for distance measurement in the FMCW LiDAR, but also can be used to temporarily store data that has been output or will be output.

Refer to FIG. 9, a structure diagram of a distance measuring device containing an FMCW LiDAR is illustrated in FIG. 9. The device 100 provided includes a body 10, and the FMCW LiDAR 101 installed on the body 10. The device 100 achieves distance measurement via the FMCW LiDAR 101 in the body 10 by executing computer programs in the FMCW LiDAR 101. In some feasible embodiments, the device 100 can be an on-vehicle FMCW LiDAR distance measuring device, which will not be elaborated here.

In the above embodiment, the method for distance measurement in the FMCW LiDAR, the FMCW LiDAR, and the distance measuring device mentioned-above obtain multiple transformed frequencies by performing the FFT on the difference frequency signal and conduct the CFAR detection to acquire the target frequency while eliminating interference frequencies. Then, frequency estimation is configured to obtain the difference frequency, completing the distance measurement. This not only improves the accuracy of the calculation but also eliminates interference frequencies, enabling processing of signals within specific frequency bands.

The above disclosed preferred embodiments of the invention are intended only to assist in the elaboration of the invention. The preferred embodiment does not elaborate on all the details and does not limit the invention to a specific embodiment. Obviously, according to the contents of this instruction manual, a lot of amendments and changes can be made. These embodiments are selected and described in detail in this specification for the purpose of better explaining the principle and practical application of the invention, so that the technical personnel in the technical field can better understand and utilize the invention. The invention is limited only by the claims and their full scope and equivalents.

The above are only the preferred embodiments of this invention and do not therefore limit the patent scope of this invention. And equivalent structure or equivalent process transformation made by the specification and the drawings of this invention, either directly or indirectly applied in other related technical fields, shall be similarly included in the patent protection scope of this invention.

1. A method for distance measurement in an FMCW LiDAR, the method comprising:
performing an FFT on a difference frequency signal containing target state information to obtain multiple transformed frequencies, and an amplitude corresponding to each transformed frequency;
conducting a CFAR detection among the multiple transformed frequencies to detect a target frequency;
performing a coarse frequency estimation based on the FFT on the target frequency to obtain a coarse estimated value of the target frequency, the coarse estimated value being configured to calculate a difference frequency corresponding to a measured distance;
conducting a fine frequency estimation based on a DFT on the coarse estimated value to obtain a fine estimated value of the target frequency, the fine estimated value being configured to calculate the difference frequency corresponding to the measured distance;
calculating the coarse estimated value and the fine estimated value to obtain the difference frequency.

2. The method according to claim 1, wherein the target state information includes distance information between a target and the LiDAR; the performing an FFT on a difference frequency signal containing target state information to obtain multiple transformed frequencies, and an amplitude corresponding to each transformed frequency comprising:
acquiring an FFT size of the FFT, a quantity of transformed frequencies obtained by the FFT being affected by the FFT size;
performing the FFT on the difference frequency signal according to the FFT size, with each transformed frequency corresponding to each quantity of transform points.

3. The method according to claim 1, wherein the CFAR detection is configured to filter and remove interference from the transformed frequencies; the conducting a CFAR detection among the multiple transformed frequencies to detect a target frequency comprising:
comparing each transformed frequency with a plurality of preset detection thresholds one by one, and regarding the transformed frequencies less than or equal to the detection thresholds as filtered frequencies;
acquiring a clutter power based on the amplitudes corresponding to the filtered frequencies, the clutter power being configured to remove interference frequencies;
detecting the target frequency among the filtered frequencies based on the clutter power and a preset threshold factor.

4. The method according to claim 3, wherein in the CFAR detection, each amplitude is placed in a detection unit, each detection unit comprises a front sliding window and a rear sliding window, each sliding window contains a plurality of amplitudes; the acquiring a clutter power based on the amplitudes corresponding to the filtered frequencies comprising:
comparing each amplitude in the front sliding window with a preset front sliding window threshold, and each amplitude in the rear sliding window with a preset rear sliding window threshold one by one, and separately recording a quantity of amplitudes below the front and rear sliding window thresholds;
calculating a sliding window clutter power, a standard deviation of amplitudes, and divergence value for the front and rear sliding windows based on the quantity of amplitudes, the sliding window clutter power being a cumulative result of each amplitude below the sliding window threshold in the sliding window, a calculation formula for the divergence value being as follows:
$${K}_{i} = \frac{σ - {σ}_{i}}{{σ}_{i}} + ln ( \frac{{σ}_{i}}{σ} ) , i = 1 , 2 ,$$
wherein K₁ represents a divergence value for the front sliding window, K₂ represents a divergence value for the rear sliding window, σ represents the standard deviation of all amplitudes, σ₁ represents an amplitude standard deviation for the front sliding window, σ₂ represents an amplitude standard deviation for the rear sliding window;
comparing each divergence value with a preset clutter threshold one by one, and regarding a sliding window clutter power corresponding to the divergence value above the preset clutter threshold as the clutter power;
regarding the sliding window clutter power corresponding to the maximum divergence value among the divergence values as the clutter power when all divergence values being greater than or less than the clutter threshold.

5. The method according to claim 4, wherein the detecting the target frequency among the filtered frequencies based on the clutter power and a preset threshold factor comprising:
setting an amplitude threshold for the CFAR detection based on the clutter power and the preset threshold factor, a calculation formula for the amplitude threshold being as follows:
Z=T*Cₖ,
wherein Z is the amplitude threshold, T is the preset threshold factor, Cₖ is the clutter power;
comparing each amplitude with the amplitude threshold one by one, and regarding the maximum value among the filtered frequencies corresponding to the amplitudes greater than the amplitude threshold as the target frequency.

6. The method according to claim 1, wherein the coarse estimated value is an amplitude corresponding to the target frequency; the conducting a fine frequency estimation based on a DFT on the coarse estimated value to obtain a fine estimated value of the target frequency comprising:
sequentially selecting four frequency values before and after the frequency corresponding to the coarse estimated value according to the FFT size, and calculating the fine estimated value based on the four frequency values before and after the frequency corresponding to the coarse estimated value.

7. The method according to claim 6, wherein the frequency corresponding to the coarse estimated value is f_{c}, the four frequency values before are f_{c-4}, f_{c-3}, f_{c-2}, f_{c-1}, and the four frequency values after are f_{c+1}, f_{c+2}, f_{c+3}, f_{c+4}, with the frequency values corresponding to indices that are the same as the difference between the index of the frequency corresponding to the coarse estimated value and the index thereof; the sequentially selecting four frequency values before and after the frequency corresponding to the coarse estimated value according to the FFT size, and calculating the fine estimated value based on the four frequency values before and after the frequency corresponding to the coarse estimated value comprising:
calculating each fine estimation component based on the frequency values corresponding to the indices, a calculation formula for the fine estimation component being as follows:
$${α}_{k} = \frac{N}{π} {tan}^{- 1} [ tan ( \frac{π}{N} k ) Re \{ \frac{{R}_{c - k} * {e}^{j \frac{π}{N} k} - {R}_{c + k} * {e}^{- j \frac{π}{N} k}}{\frac{2 {R}_{c}}{cos ( \frac{π}{N} k )} - {R}_{c + k} * {e}^{- j \frac{π}{N} k} - {R}_{c - k} * {e}^{j \frac{π}{N} k}} \} ] , k = 1 , 2 , 3 , 4 ,$$
wherein R_{c-k} is the difference between the amplitude corresponding to the kth frequency value before the frequency corresponding to the coarse estimated value and the coarse estimated value, R_{c+k} is the difference between the amplitude corresponding to the kth frequency value after the frequency corresponding to the coarse estimated value and the coarse estimated value;
calculating the fine estimated value based on the fine estimation components, a calculation formula for the fine estimated value being as follows:
$$α = \frac{{\sum }_{k = 1}^{4} {( \frac{N}{π k} )}^{2} * {α}_{k}}{{\sum }_{k = 1}^{4} {( \frac{Nk}{π} )}^{2}} , k = 1 , 2 , 3 , 4 ,$$
wherein α represents the fine estimated value.

8. The method according to claim 2, wherein a calculation formula for calculating the coarse estimated value and the fine estimated value to obtain the difference frequency is as follows:
fᵣ=f_{c}+α*F_{S}/N,
wherein fᵣ represents the difference frequency, N represents the FFT size, F_{S} represents the corresponding sampling frequency.

9. An FMCW LiDAR, the FMCW LiDAR comprising:
a memory, configured to store computer programs; and
a processor, configured to execute the computer programs to implement a method for distance measurement in the FMCW LiDAR, the method comprising:
performing an FFT on a difference frequency signal containing target state information to obtain multiple transformed frequencies, and an amplitude corresponding to each transformed frequency;
conducting a CFAR detection among the multiple transformed frequencies to detect a target frequency;
performing a coarse frequency estimation based on the FFT on the target frequency to obtain a coarse estimated value of the target frequency, the coarse estimated value being configured to calculate a difference frequency corresponding to a measured distance;
conducting a fine frequency estimation based on a DFT on the coarse estimated value to obtain a fine estimated value of the target frequency, the fine estimated value being configured to calculate the difference frequency corresponding to the measured distance;
calculating the coarse estimated value and the fine estimated value to obtain the difference frequency.

10. The FMCW LiDAR according to claim 9, wherein the target state information includes distance information between a target and the LiDAR; the performing an FFT on a difference frequency signal containing target state information to obtain multiple transformed frequencies, and an amplitude corresponding to each transformed frequency comprising:
acquiring an FFT size of the FFT, a quantity of transformed frequencies obtained by the FFT being affected by the FFT size;
performing the FFT on the difference frequency signal according to the FFT size, with each transformed frequency corresponding to each quantity of transform points.

11. The FMCW LiDAR according to claim 9, wherein the CFAR detection is configured to filter and remove interference from the transformed frequencies; the conducting a CFAR detection among the multiple transformed frequencies to detect a target frequency comprising:
comparing each transformed frequency with a plurality of preset detection thresholds one by one, and regarding the transformed frequencies less than or equal to the detection thresholds as filtered frequencies;
acquiring a clutter power based on the amplitudes corresponding to the filtered frequencies, the clutter power is configured to remove interference frequencies;
detecting the target frequency among the filtered frequencies based on the clutter power and a preset threshold factor.

12. The FMCW LiDAR according to claim 11, wherein in the CFAR detection, each amplitude is placed in a detection unit, each detection unit comprises a front sliding window and a rear sliding window, each sliding window contains a plurality of amplitudes; the acquiring a clutter power based on the amplitudes corresponding to the filtered frequencies comprising:
comparing each amplitude in the front sliding window with a preset front sliding window threshold, and each amplitude in the rear sliding window with a preset rear sliding window threshold one by one, and separately recording a quantity of amplitudes below the front and rear sliding window thresholds;
calculating a sliding window clutter power, a standard deviation of amplitudes, and divergence value for the front and rear sliding windows based on the quantity of amplitudes, the sliding window clutter power being a cumulative result of each amplitude below the sliding window threshold in the sliding window, a calculation formula for the divergence value being as follows:
$${K}_{i} = \frac{σ - {σ}_{i}}{{σ}_{i}} + ln ( \frac{{σ}_{i}}{σ} ) , i = 1 , 2 ,$$
wherein K₁ represents a divergence value for the front sliding window, K₂ represents a divergence value for the rear sliding window, σ represents the standard deviation of all amplitudes, σ₁ represents an amplitude standard deviation for the front sliding window, σ₂ represents an amplitude standard deviation for the rear sliding window;
comparing each divergence value with a preset clutter threshold one by one, and regarding a sliding window clutter power corresponding to the divergence value above the preset clutter threshold as the clutter power;
when all divergence values being greater than or less than the clutter threshold, regarding the sliding window clutter power corresponding to the maximum divergence value among the divergence values as the clutter power.

13. The FMCW LiDAR according to claim 12, wherein the detecting the target frequency among the filtered frequencies based on the clutter power and a preset threshold factor comprising:
setting an amplitude threshold for the CFAR detection based on the clutter power and the preset threshold factor, a calculation formula for the amplitude threshold being as follows:
Z=T*Cₖ,
wherein Z is the amplitude threshold, T is the preset threshold factor, Cₖ is the clutter power;
comparing each amplitude with the amplitude threshold one by one, and regarding the maximum value among the filtered frequencies corresponding to the amplitudes greater than the amplitude threshold as the target frequency.

14. The FMCW LiDAR according to claim 9, wherein the coarse estimated value is an amplitude corresponding to the target frequency; the conducting a fine frequency estimation based on a DFT on the coarse estimated value to obtain a fine estimated value of the target frequency comprising:
sequentially selecting four frequency values before and after the frequency corresponding to the coarse estimated value according to the FFT size, and calculating the fine estimated value based on the four frequency values before and after the frequency corresponding to the coarse estimated value.

15. The FMCW LiDAR according to claim 14, wherein the frequency corresponding to the coarse estimated value is f_{c}, the four frequency values before are f_{c-4}, f_{c-3}, f_{c-2}, f_{c-1}, and the four frequency values after are f_{c+1}, f_{c+2}, f_{c+3}, f_{c+4}, with the frequency values corresponding to indices that are the same as the difference between the index of the frequency corresponding to the coarse estimated value and the index thereof; the sequentially selecting four frequency values before and after the frequency corresponding to the coarse estimated value according to the FFT size, and calculating the fine estimated value based on the four frequency values before and after the frequency corresponding to the coarse estimated value comprising:
calculating each fine estimation component based on the frequency values corresponding to the indices, a calculation formula for the fine estimation component being as follows:
$${α}_{k} = \frac{N}{π} {tan}^{- 1} [ tan ( \frac{π}{N} k ) Re \{ \frac{{R}_{c - k} * {e}^{j \frac{π}{N} k} - {R}_{c + k} * {e}^{- j \frac{π}{N} k}}{\frac{2 {R}_{c}}{cos ( \frac{π}{N} k )} - {R}_{c + k} * {e}^{- j \frac{π}{N} k} - {R}_{c - k} * {e}^{j \frac{π}{N} k}} \} ] , k = 1 , 2 , 3 , 4 ,$$
wherein R_{c-k} is the difference between the amplitude corresponding to the kth frequency value before the frequency corresponding to the coarse estimated value and the coarse estimated value, R_{c+k} is the difference between the amplitude corresponding to the kth frequency value after the frequency corresponding to the coarse estimated value and the coarse estimated value;
calculating the fine estimated value based on the fine estimation components, a calculation formula for the fine estimated value being as follows:
$$α = \frac{{\sum }_{k = 1}^{4} {( \frac{N}{π k} )}^{2} * {α}_{k}}{{\sum }_{k = 1}^{4} {( \frac{Nk}{π} )}^{2}} , k = 1 , 2 , 3 , 4 ,$$
wherein α represents the fine estimated value.

16. The FMCW LiDAR according to claim 10, wherein a calculation formula for calculating the coarse estimated value and the fine estimated value to obtain the difference frequency is as follows:
fᵣ=f_{c}+α*F_{S}/N,
wherein fᵣ represents the difference frequency, N represents the FFT size, F_{S} represents the corresponding sampling frequency.

17. A distance measuring device, the device comprising:
a body; and
a FMCW LiDAR, installed on the body, the FMCW LiDAR comprising:
a memory, configured to store computer programs; and
a processor, configured to execute the computer programs to implement a method for distance measurement in the FMCW LiDAR, the method comprising:
performing an FFT on a difference frequency signal containing target state information to obtain multiple transformed frequencies, and an amplitude corresponding to each transformed frequency;
conducting a CFAR detection among the multiple transformed frequencies to detect a target frequency;
performing a coarse frequency estimation based on the FFT on the target frequency to obtain a coarse estimated value of the target frequency, the coarse estimated value being configured to calculate a difference frequency corresponding to a measured distance;
conducting a fine frequency estimation based on a DFT on the coarse estimated value to obtain a fine estimated value of the target frequency, the fine estimated value being configured to calculate the difference frequency corresponding to the measured distance;
calculating the coarse estimated value and the fine estimated value to obtain the difference frequency.

18. The device according to claim 17, wherein the target state information includes distance information between a target and the LiDAR; the performing an FFT on a difference frequency signal containing target state information to obtain multiple transformed frequencies, and an amplitude corresponding to each transformed frequency comprising:
acquiring an FFT size of the FFT, a quantity of transformed frequencies obtained by the FFT being affected by the FFT size;
performing the FFT on the difference frequency signal according to the FFT size, with each transformed frequency corresponding to each quantity of transform points.

19. The device according to claim 17, wherein the CFAR detection is configured to filter and remove interference from the transformed frequencies; the conducting a CFAR detection among the multiple transformed frequencies to detect a target frequency comprising:
comparing each transformed frequency with a plurality of preset detection thresholds one by one, and regarding the transformed frequencies less than or equal to the detection thresholds as filtered frequencies;
acquiring a clutter power based on the amplitudes corresponding to the filtered frequencies, the clutter power is configured to remove interference frequencies;
detecting the target frequency among the filtered frequencies based on the clutter power and a preset threshold factor.

20. The device according to claim 17, wherein the coarse estimated value is an amplitude corresponding to the target frequency; the conducting a fine frequency estimation based on a DFT on the coarse estimated value to obtain a fine estimated value of the target frequency comprising:
sequentially selecting four frequency values before and after the frequency corresponding to the coarse estimated value according to the FFT size, and calculating the fine estimated value based on the four frequency values before and after the frequency corresponding to the coarse estimated value.
